(19) United States
(12) Patent Application Publication
(10) Pub. No.: US 2017/0352065 A1
(43) Pub. Date: Dec. 7, 2017

(54) Systems and Methods for Use in Facilitating Donation Transactions

(71) Applicant: MASTERCARD INTERNATIONAL INCORPORATED, Purchase, NY (US)

(72) Inventor: LaShana Lewis, St. Louis, MO (US)

(21) Appl. No.: 15/171,019

(22) Filed: Jun. 2, 2016

(51) Int. Cl. G06Q 30/02; G06Q 20/40; G06Q 20/10

(52) U.S. Cl. CPC G06Q 30/0279; G06Q 20/102; G06Q 20/401

(57) ABSTRACT

Systems and methods are provided for use in performing donation transactions between donors and donees. One exemplary method includes obtaining, by a computing device, an identifier for a donee device associated with a donation account for an individual donee and accessing data for the donation account based on the identifier. The data, associated with the donation account, may include at least one donation goal for the donee, at least one spending restriction for the donation account, and/or an image of the donee. The method also includes displaying to a donor, by the computing device, the accessed data for the donation account and then soliciting a donation from the donor for the donee. The method further includes causing a payment account transaction for the donation, whereby when the payment account transaction is authorized, the donation is appended to the donation account for the individual donee.

### FIELD

The present disclosure generally relates to systems and methods for use in facilitating donation transactions and, more particularly, for example, for use in enabling donors to make donations to recipients (or donees) via electronic donation transactions.

### BACKGROUND

This section provides background information related to the present disclosure which is not necessarily prior art.

People often seek out ways to help less fortunate individuals and/or individuals in need of assistance, be it in response to a natural disaster or tragedy, or through a desire to simply help someone down on their luck. Typically, such help is in the form of donations to the individuals. However, it can be difficult to determine appropriate avenues for providing the donations. While the people making the donations want to be generous, they also want to be confident that their donations, and particularly their monetary donations, are directed to individuals truly in need and will likely be used in a manner related to such need.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating donation transactions between donors and donees;

FIG. 2 is a block diagram of a computing device that may be used in the exemplary system of FIG. 1;

FIG. 3 is an exemplary method, which may be implemented in connection with the system of FIG. 1, for facilitating a donation transaction by a donor to a donee;

FIG. 4 is an exemplary device that can be issued to a donee and used in a donation transaction in connection with the system of FIG. 1 and/or method of FIG. 3; and

FIGS. 5-6 are exemplary interfaces that may be displayed at a computing device, associated with a donor, in connection with a donation transaction by the donor to a donee, as facilitated by the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

There are many causes, from individuals in need of assistance to national charity organizations, which call for donations. Many people are willing to provide donations to such causes, but are unable to do so (and/or are discouraged from doing so) because of certain facets of conventional donation processes. For example, donors may not have funds immediately available to provide the donations (particularly where the causes relate to, or include, individuals/donees in need of assistance and encountered by the potential donors during routine daily activities). In addition, donors may be unsure about appropriate avenues or methods for making the donations, and/or donors may want assurances that the donations will actually be used to provide assistance to the selected causes (and their donees). Uniquely, the systems and methods herein enable donors to make donations to selected donees via secure payment account transactions. As such, funds for the donations (e.g., cash, etc.) need not be immediately accessible to the donors when they encounter the donees (or when they desire to make the donations). What's more, as part of the transactions, the donors can confirm that the donees are indeed in need of assistance (e.g., are registered with charity organizations, etc.), prior to making donations, and can further define particular parameters (e.g., limitations, etc.) specifying how the donees can use the donations.

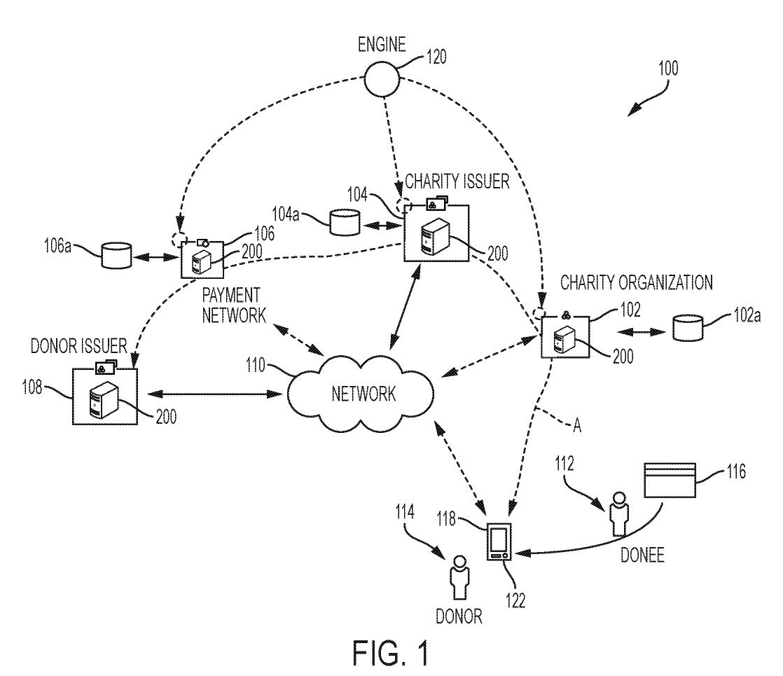

FIG. 1 illustrates an exemplary system 100 in which the one or more aspects of the present disclosure may be implemented. Although the system 100 is presented in one arrangement, other embodiments may include the parts of the system 100 (or other parts) arranged otherwise depending on, for example, distribution of donation information to donors and/or donees, processing of payment account transactions, etc.

The system 100 generally includes a charity organization 102, a charity issuer 104, a payment network 106, and a donor issuer 108, each coupled to, and in communication with (and/or with access to), network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. For example, network 110 may include multiple different networks, such as a private network made accessible by the payment network 106 to the issuers 104, 108 and, separately, a public network (e.g., the Internet, etc.) through which the charity organization 102 and the charity issuer 104 may communicate.

The charity organization 102 in the system 100 is associated with donees in need of assistance (e.g., individuals, groups of individuals, etc.), for example, individual donee 112 (also referred to as a recipient herein). Generally, the donees register with the charity organization 102 in order to receive the assistance. For example, the donees may create profiles, through the charity organization 102, that include pictures of the donees and contact information (e.g., for verification purposes, etc.), as well as donation goals relating to particular areas of need/assistance (e.g., rent, groceries, utilities, transportation, education, etc.) (as set by the donees, or by the charity organization 102, or by a combination thereof), donation history, etc. The profiles may then be stored in data structure 102a associated with the charity organization 102 for subsequent reference/use, as described herein. In connection therewith, the charity organization 102 is then configured to allow/provide access, by the donees (once registered), to donated funds from donors such as, for example, donor 114. It should be appreciated that the charity organization 102 may relate to, or may encompass, donees sharing a common need for assistance (e.g., donees in need of assistance following a natural disaster, etc.), or the charity organization 102 may relate to, or may encompass, donees in general (e.g., any donees in need of assistance, regardless of reason; etc.). In addition, the donors may include individual donors (such as donor 114), groups of donors, companies, etc.

The charity organization 102, in conjunction with the charity issuer 104, is also configured to provide donation accounts to the registered donees, and supply the accounts with donated funds as appropriate. Donee devices (e.g., issued by the charity issuer 104, etc.), such as donee device 116, are then associated with (e.g., are assigned to, etc.) the donees (e.g., donee 112, etc.), to facilitate access to the donation accounts (and the funds therein). In particular, identifiers for the donee devices (e.g., primary account numbers (PANs), card account numbers, donee names, etc.) may be associated with the donees through their profiles at the charity organization 102. The donee devices may include, without limitation, debit/credit cards or other account cards, computing devices configured to run account access applications (e.g., electronic wallet applications, etc.), fobs, wearable devices, or the like. Data associated with the donation accounts (e.g., data related to the donee profiles, identifiers for the donation accounts, other account data, etc.) can then be stored in a data structure 104a associated with the charity issuer 104 (and/or in the data structure 102a associated with the charity organization 102).

The donation accounts are also associated with various restrictions (broadly, account data) that limit use of the donation accounts by the donees (although such restrictions are not required in all embodiments). Without limitation, such restrictions may relate to merchants, merchant categories, products, product categories, and/or spend amounts. For example, a donation account may include a restriction that inhibits use of the donation account to purchase alcohol or tobacco (or to effect transactions at merchants associated with alcohol or tobacco). As another example, a donation account may include a restriction that only allows use of funds from the account on groceries or education (or at merchants associated therewith). As still another example, a donation account may include a restriction that inhibits use of the donation account to purchase pharmaceutical or medicinal products (e.g., in general or based on abuse history, etc.). The restrictions may be set by the charity organization 102, and may be generic to all of the donation accounts for the charity organization 102. Or, the restrictions may be specific to donation accounts for particular donees (e.g., based on prior purchase histories for the donees, etc.). In addition, the restrictions may be stored in data structure 102a associated with the charity organization, in data structure 104a associated with the charity issuer, and/or data structure 106a associated with the payment network 106, based on desired access.

In an exemplary transaction by the donee 112, using the donee device 116, the donee 112 provides payment credentials associated with the donation account (e.g., a PAN, etc.) to a merchant (not shown), in exchange for desired products (e.g., goods, services, combinations thereof, etc.). In turn, the merchant submits an authorization request for the transaction to the charity issuer 104 (as the issuer of the donation account), via an acquirer (associated with the merchant) and through the payment network 106 (e.g., through MasterCard®, VISA®, Discover®, American Express®, etc.). The charity issuer 104 is configured to determine whether the donation account for the donee 112 is in good standing and whether there are sufficient funds and/or credit to cover the transaction. The charity issuer 104 (or, potentially, the payment network 106) is also configured to determine if the transaction is in compliance with any restrictions associated with the donation account (e.g., as set by the charity organization 102, as subsequently requited by donors, etc.). If the charity issuer 104 approves the transaction, an authorization reply or response (indicating the approval of the transaction) is transmitted back from the charity issuer 104 to the merchant, thereby permitting the merchant to complete the transaction. The transaction is later cleared and/or settled (via appropriate transaction messages such as clearing messages and/or settlement messages) by and between the merchant, the acquirer, and the charity issuer 104 (by appropriate agreements). If the transaction is declined, however, the authorization reply (indicating a decline of the transaction) is provided back to the merchant, thereby permitting the merchant to halt or terminate the transaction or request other forms of payment.

Transaction data is generated, collected, and stored as part of the above interactions among the merchant, the acquirer, the payment network 106, the charity issuer 104, and the donee 112. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure 106a associated with the payment network 106, etc.). Additionally, or alternatively, the acquirer and/or the charity issuer 104 may store the transaction data, or part thereof, in a data structure (e.g., in data structure 104a, etc.), or transaction data may be transmitted between parts of system 100 as used or needed. As used herein, transaction data may include, for example (and without limitation), PANs for consumers involved in the transactions, amounts of the transactions, merchant IDs for merchants involved in the transactions, merchant category codes (MCCs), dates/times of the transactions, account restrictions, etc. It should be appreciated that more or less information related to transactions, as part of either authorization or clearing and/or settling, may be included in transaction records and stored within the system 100.

In various exemplary embodiments, donees (e.g., donee 112, etc.) involved in the different transactions herein are prompted to agree to legal terms associated with their donation accounts, for example, during enrollment in their accounts with the charity organization 102 and/or the charity issuer 104, etc. In so doing, the donees may voluntarily agree, for example, in exchange for the donation accounts, to allow merchants, issuers, payment networks, charity organizations, etc., to use data collected during enrollment and/or collected in connection with processing transactions herein, subsequently for one or more of the different purposes described herein.

In FIG. 1, the charity organization 102 and the charity issuer 104 are illustrated as separate parts of the system 100. However, it should be appreciated that the charity organization 102 and the charity issuer 104 may be closely related entities or sub-entities of a single entity in other embodiments. In addition, while only one charity organization 102, one charity issuer 104, one payment network 106, one donor issuer 108, one donee 112, and one donor 114 are illustrated in FIG. 1, it should be appreciated that any number of these parts/entities/persons may be included in other system embodiments. Further, while the donee 112 is described as associated with the one charity organization, it should be appreciated that the donee 112 may be associated with multiple different charity organizations in other embodiments, for example, depending on need (and, in connection therewith, may have a single donation account associated with all of the multiple different charity organizations, or may have multiple donation accounts, with one account for each of the multiple different charity organizations). Moreover, while the data structures 102a, 104a, 106a are illustrated in FIG. 1 as separate data structures associated with the charity organization 102, the charity issuer 104, and the payment network 106, respectively, in other embodiments the data structures 102a, 104a, 106a may be associated, together or separately, with and/or implemented by a donation engine 120 (either separate from the charity organization 102, the charity issuer 104, and the payment network 106 or (as indicated by the dotted lines) incorporated, in whole or in part, in one or more of the charity organization 102, the charity issuer 104, and the payment network 106).

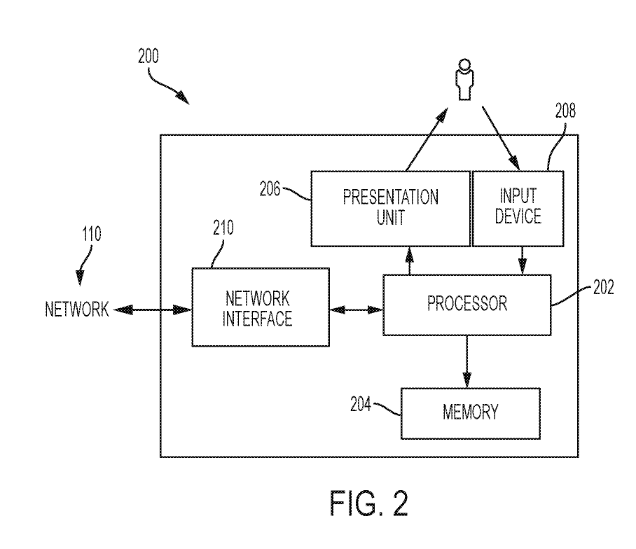

FIG. 2 illustrates exemplary computing device 200 used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are configured to function as described herein.

In the system 100, the charity organization 102, the charity issuer 104, the payment network 106, and the donor issuer 108 are each illustrated as incorporating a computing device 200, coupled to the network 110. In addition, in some implementations of the system 100, the donee device 116 associated with the donee 112 may include a computing device (e.g., a smartphone, a tablet, etc.) consistent with computing device 200. Further, as described more hereinafter, the donor 114 is associated with a communication device 118 (e.g., a smartphone, a tablet, etc.), which is generally consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, donee profiles, transaction data, donation account data (e.g., account identifiers, donor preferences, donee goals, charity information, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., charity information, donor preferences, donee information, other donation data, etc.), visually, for example, to a user of the computing device 200, such as, for example, donor 114, users associated with the charity organization 102, etc. Various interfaces (e.g., as defined by network-based applications and/or conventional applications, etc.) may be displayed at computing device 200, and in particular at presentation unit 206, to display and/or solicit certain information, as described herein, for example, and displayed at the presentation unit 206. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, login information from the donor 114, a donation amount, donation preferences, etc. The input device 208 is coupled to (and is in communication with) the processor 202 and may include, for example, one or more of a keyboard, a pointing device, a mouse, a stylus, a card reader, a camera, a touch sensitive panel (e.g., a touch pad or a touch screen, etc.), and/or other suitable input device. Further, in various exemplary embodiments, a touch screen may behave as both a presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, a radio-frequency identification (RFID) adapter, etc.), a mobile network adapter, or other device capable of communicating to one or more different networks, including the network 110. In some exemplary embodiments, the computing device 200 includes the processor 202 and one or more network interfaces (including the network interface 210) incorporated into or with the processor 202.

Referring again to FIG. 1, the system 100 also includes the donation engine 120 configured to perform one or more of the operations described herein. In general, the donation engine 120 is configured to facilitate donation transactions by donors (e.g., by the donor 114, etc.) to donees (e.g., to the donee 112, etc.), via the charity organization 102. As shown, the donation engine 120 is a separate part of the system 100, and may operate apart from (but still in communication with, for example, via network 110) the charity organization 102, the charity issuer 104, the payment network 106, and the donor issuer 108 to facilitate the donation transactions (and to access data to perform the various operations described herein). However, in other embodiments, the donation engine 120 may actually be incorporated, in whole or in part, into one or more parts of the system 100, for example, the charity organization 102, the charity issuer 104, and/or the payment network 106 (as indicated by the dotted lines in FIG. 1). In addition, the donation engine 120 should be understood to be embodied in at least one computing device in communication with the network 110, which may be generally consistent with the computing device 200, and specifically configured, via executable instructions, to perform as described herein, and/or embodied in at least one non-transitory computer readable media.

Also in the system 100, the communication device 118 associated with the donor 114 includes (or is associated with) a donation application 122, through which the communication device 118 is configured to communicate with the donation engine 120 to facilitate donation transactions by the donor 114 (e.g., to the donee 112, etc.). The donation application 122 may be available, to the donor 114, for example, from the charity organization 102, the charity issuer 104, the payment network 106, etc. In addition, once received by the donor 114, the donation application 122 may be stored and/or executed on the communication device 118, and may take the form of an application local to the communication device 118, or a network-based application (or a combination thereof). Further, the donation application 122 may be a stand-alone application or it may be a part of another application (e.g., part of an electronic wallet application, a banking application, a payment network-centric application, etc.).

The donation application 122 may include various user authentication features (e.g., a sign-on process including a password or personal identification number (PIN), etc.) to help ensure security in facilitating the transactions, as well as various account storage features for data associated with the transactions (e.g., access to an electronic wallet application enabling retrieval and/or entry of payment account credentials for one or more payment accounts associated with the donor 114 for use in a donation transaction, etc.).

In an example donation transaction, when the donor 114 encounters the donee 112, and desires to make a donation specifically to the donee 112 (or to the charity organization 102 for specific distribution to the donee 112), the donor 114 uses the communication device 118 to interact with the donee device 116 associated with the donee 112 (via the donation application 122 and the donation engine 120), to obtain various information about the donee 112 and/or about the charity organization 102 (with which the donee 112 is associated). In particular, the communication device 118 (via the donation application 122) is configured to obtain an identifier for the donee device 116 (e.g., via manual input by the donor 114, via network communication using network interface 210, via other input means, etc.), and communicate the identifier to the donation engine 120 (via network 110). As described above, the identifier may include the PAN for the donation account associated with the donee device 116, a card account number for the donee device 116, a token, a name associated with the donee 112, another identifier, etc. Additional information and/or data may also be presented via the donee device 116, as part of the identifier or separate therefrom, such as, for example, a donee image, a donee address, other donee biographical data, an identifier for the charity organization 102, etc. (all broadly account data). In various embodiments, the identifier may be encrypted or presented as computer-readable indicia so that the identity of the donee 112 is protected.

In turn, the donation engine 120 is configured to retrieve donation account data for the donee 112 (and/or for the charity organization 102), based on the identifier (e.g., from one or more of data structures 102a, 104a, 106a, etc.). As indicated above, the donation account data may include, for example, an image (or other form of authenticatable identification) of the donee 112, credentials for the donation account (e.g., a PAN, etc.), and transaction data for prior transactions effected by the donee 112 to the donation account (e.g., as retrieved from data structure 106a associated with the payment network 106, etc.). And, retrieving such data may include requesting the data, as necessary, from the charity organization 102, the charity issuer 104, and/or the payment network 106 (e.g., via communications therebetween, etc.). Alternatively, retrieving such data may include directly accessing the appropriate data structures 102a, 104a, 106a comprising such data (for example, when the donation engine 120 is implemented at least in part in the charity organization 102, the charity issuer 104, and/or the payment network 106), and retrieving the data therefrom (upon appropriate permissions). In any case, the donation engine 120 is configured to then communicate the data to the communication device 118.

Upon receipt of the donation account data for the donee 112, the communication device 118 is configured (via the donation application 122) to display the account data, to the donor 114, and solicit a donation input from the donor 114. The donation input may include, for example, various details of/for the donation (broadly, donation definitions/preferences) such as: a donation amount; an instruction/indication directing the donation to the donee 112 associated with the identifier obtained from the donee device 116; instructions/indications limiting the donation to particular merchants, particular categories of merchants, particular products, particular categories of products, etc.; instructions/indications restricting the donation from use at particular merchants, particular categories of merchants, on particular products, on particular categories of products, etc.; etc. For example, the donor 114 may provide a donation for $10.00 to the donee 112, but specify a donor preference limiting use of the donation to groceries (as an added restriction to be applied when the donee 112 uses the donation account, as described above).

Next, once the donation input is received from the donor 114, generally defining the donation to the donee 112, the communication device 118 is configured (via the donation application 122) to initiate a payment account transaction for the donation (broadly, a donation transaction). In connection therewith, the communication device 118 is configured to submit the transaction to the charity organization 102 (with which the donee 112 is associated), via the donation engine 120, identifying the donation as well as the donee 112. In turn, the charity organization 102 is configured to generate an authorization request for the donation transaction. The authorization request includes credentials for a payment account provided by the donor 114 to fund the donation (via the donation application 122) as well as the various details for the donation specified by the donor 114 (e.g., donation amount, donor preferences, etc.). The charity organization 102 then transmits the authorization request to the donor issuer 108, along path A in FIG. 1, via the charity issuer 104 (now acting as an acquirer) and the payment network 106, to determine whether the donor's payment account is in good standing and whether sufficient funds and/or credit are available to cover the donation transaction. Alternatively, the communication device 118, via the donation application 122 and the donation engine 120, may be configured to generate the authorization request for the donation transaction, and transmit the authorization request to the charity organization 102 (or, potentially, directly to the charity issuer 104, depending on location of the donation engine 120). In either case, if approved, an authorization reply (indicating the approval of the donation transaction) is transmitted back from the donor issuer 108 to the charity organization 102, again along path A, thereby permitting the charity organization 102 to complete the transaction (e.g., append the donated funds to the donation account for the donee 112, etc.). The transaction is later cleared and/or settled by and between the charity organization 102, the charity issuer 104, and the donor issuer 108. If declined, however, the authorization reply (indicating a decline of the transaction) is provided back to the charity organization 102, thereby permitting the charity organization 102 to halt or terminate the donation transaction.

In various embodiments, when the charity organization 102 receives the donation transaction from the donor 114 (either via the communication device 118, or subsequently via the authorization reply), the charity organization 102 is configured to review the donation for potential fraud (e.g., by the donee 112, etc.). In connection therewith, the charity organization 102 may compare the data received from the donor 114, regarding the donee 112, to the donee's profile (in data structure 102a). If the comparison indicates that the donee 112 is legitimate, the charity organization 102 proceeds with the transaction. Otherwise, the charity organization may decline the transaction and further investigate for theft, fraud, or illegitimate use of the donee device 116, for example.

In addition, in various embodiments, when the donation transaction is approved, and the donated funds are appended to the donation account for the donee 112, the charity organization 102 and/or the charity issuer 104 and/or the donation engine 120 may associate the preferences provided by the donor 114 on use of the funds (as retrieved from the authorization request, for example) with the donation account for the donee 112 (e.g., as an added restriction to use of the donated funds, etc.). In so doing, the restrictions may be stored in association with the donation account (in addition to the restrictions already associated with the donation accounts by the charity organization 102), for example, in one or more of the data structures 102a, 104a, 106a associated with the charity organization 102, the charity issuer 104, and the payment network 106, respectively. The additional restrictions can then be implemented, for example, by the charity issuer 104, etc., in connection with a payment account transaction by the donee 112 using the donation account and the donated funds (as described above in connection with the example transaction by the donee 112 at the merchant). What's more, the charity organization 102 may regularly monitor transactions to the donation account to ensure that the donee 112 is still in need of such assistance.

In some embodiments, the charity organization 102 in the system 100 may implement donation drives and/or donation matching programs, to help raise donations for donees. Such programs may be routine or may be associated with special occasions (e.g., holiday matching, winter warm-up, etc.). In so doing, the programs may be implemented via the donation application 122, for example, with notifications provided to donors via their communication devices of such programs. Further, matching programs may be implemented in connection with co-sponsoring organizations (providing the matching donations to donees), as desired (e.g., again via the donation application 122, donation engine 120, or otherwise, etc.).

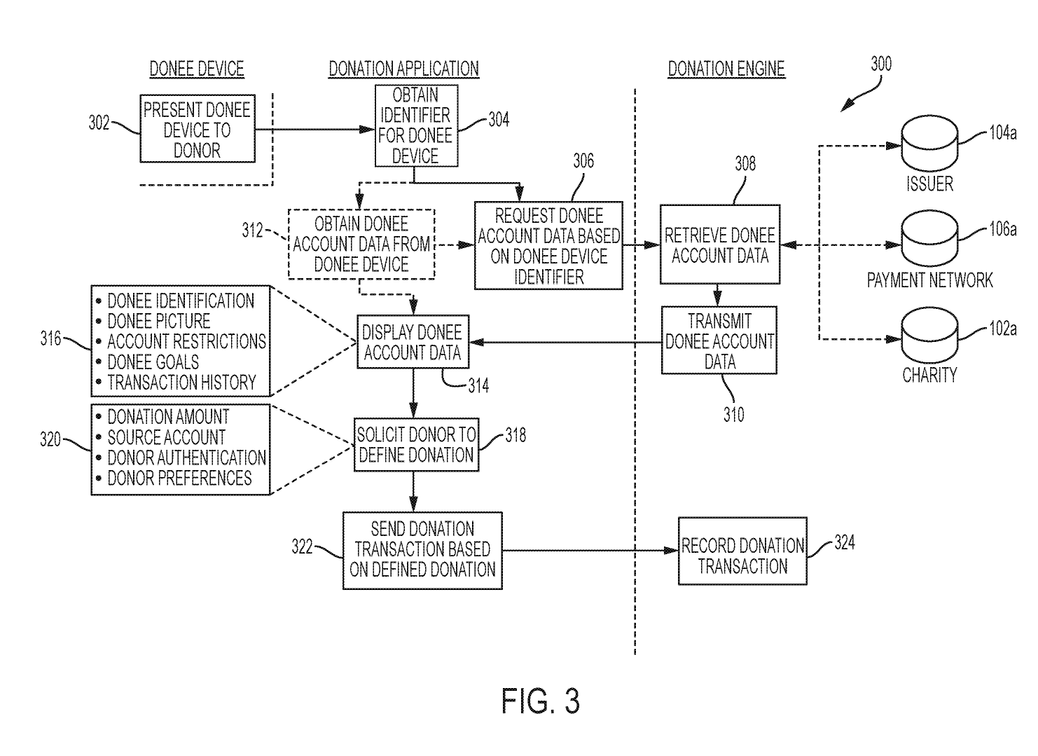

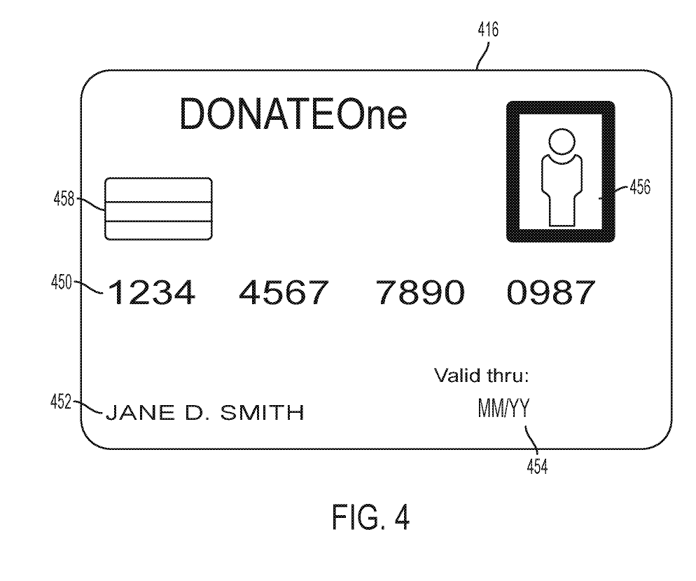

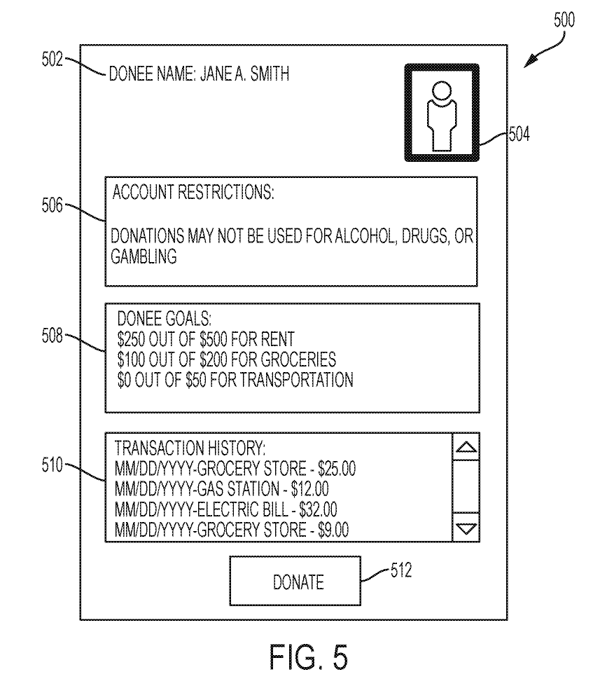

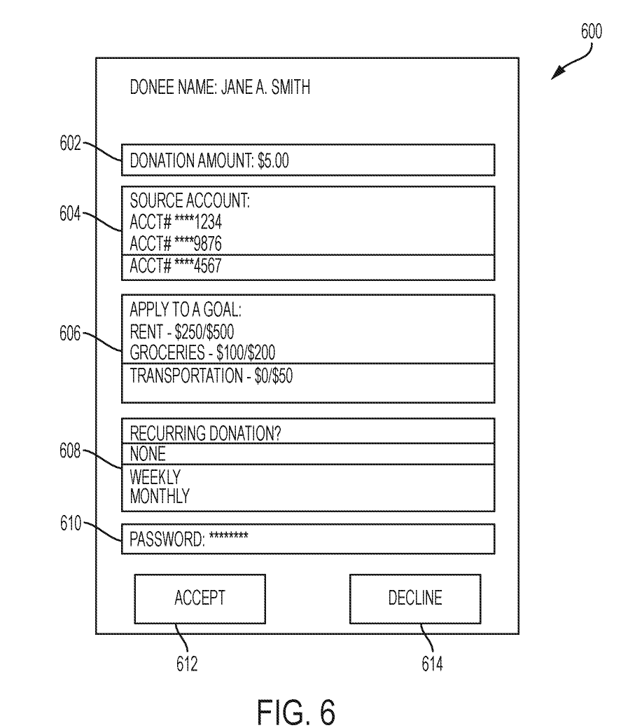

FIG. 3 illustrates an exemplary method 300 for facilitating a donation transaction, for example, between the donor 114 and the donee 112 in the system 100. The method 300 is generally described as implemented in the communication device 118 associated with the donor 114 in the system 100 and in the donation engine 120, and further with reference to the computing device 200. It should be appreciated, however, that the methods herein are not limited to the system 100 and/or the computing device 200, and conversely that the systems and computing devices herein are not limited to method 300. Further, the method 300 is described with reference to exemplary donee device 400 shown in FIG. 4, and with reference to exemplary interfaces 500 and 600 shown in FIGS. 5-6, respectively. Again, the method 300, however, should not be understood to be limited to the exemplary described device 400 and/or the exemplary interfaces 500 and 600 as other devices and/or interfaces, or no devices and/or interfaces, may be employed in methods described herein.

In the method 300, when the donor 114 desires to make a donation to the donee 112, the donee 112 initially presents an identifier to the donor 114, via the donee device 116, at 302. As previously described, the donee device 116 may include a card, such as a credit/debit card, that includes a bar code, a magnetic stripe, other indicia, and/or an embedded computer chip which may be read and/or scanned to obtain the device identifier. Alternatively, the donee device 116 may include a communication device, consistent with computing device 200, that is configured to display, emit (e.g., via NFC, Bluetooth, RFID, etc.), provide, or otherwise present the identifier for the donee device 116 to the donor 114 (and, specifically, to the donor's communication device 118).

In turn, the communication device 118, via the donation application 122, which is executed on the communication device 118, obtains the identifier from the donee device 116, at 304. The communication device 118 may scan, detect, read, or otherwise receive the identifier from (or for) the donee device 116. For instance, the identifier may be in the form of a bar code on the donee device 116 (or other indicia readable by the communication device 118), and the donation application 122 may instruct the communication device 118 (via a camera or other indicia-reading unit associated with the communication device 118) to read the bar code. Alternatively, the donor 114 may read the identifier from the donee device 116 and manually enter it into the communication device 118.

FIG. 4 illustrates an exemplary donee device 416 that may be used in the method 300 (or in the system 100). The illustrated device 416 is in the form of a card for use by the donee 112 in providing a donee device identifier to the donor 114, as described above. The donee device 416 includes a card account number 450, a name 452 of the donee 112, an expiration date 454 for the donee device 416, a picture/image 456 of the donee 112, and an embedded chip 458 (e.g., including, in electronic form, one or more of the card account number 450, the name 452 of the donee 112, the expiration date 454 for the donee device 416, and the picture/image 456 of the donee 112; etc.). The embedded chip 458 may be accessible to computing devices and/or communication devices (e.g., communication device 118 associated with the donor 114, etc.) using chip reading technology, NFC, Bluetooth, or the like.

In this example, the card account number 450 of the donee device 416 is used as the identifier for the donee device 416. As such, presenting the identifier to the donor 114 (e.g., at 302 in the method 300, etc.) may include simply showing the donee device 416 to the donor 114, or it may include transmitting the card account number 450 to the donor 112 via the embedded chip 458. In addition in this example, the name 452 of the donee 112, the expiration date 454 for the donee device 416, and the picture/image 456 of the donee 112, when presented to the donor 114 (either manually or electronically via the embedded chip 458) may allow the donor 114 to confirm/verify that the individual presenting the donee device 416 is actually the donee 112, reducing the likelihood of fraudulent use of the donee device 416 and/or the underlying donation system generally. It should be understood that the illustrated donee device 416 is merely exemplary and not limiting. Alternative embodiments of donee devices may include more, fewer, or different donee account data and/or donee data, or different devices such as smartphones, etc.

With reference again to FIG. 3, once the identifier for the donee device 116 is obtained, the communication device 118, via the donation application 122, requests, at 306, data for the donation account associated with the donee 112, based on the obtained identifier. In connection therewith, the communication device 118 transmits the request to the donation engine 120, via the network 110, for the data. In addition to the donee device identifier, the communication device 118 may also transmit, to the donation engine 120, donor information, time and date information, location information, etc. relating to the interaction between the donor 114 and the donee 112. Such additional information may be used by the donation engine 120, in some embodiments (in connection with the charity organization 102, for example), to help authenticate the donee 112 and/or help subsequently authorize the transaction (e.g., potentially, as part of a fraud review, etc.).

At 308, the donation engine 120 receives the request for the account data, including the identifier for the donee device 116, and, in response, retrieves the requested account data (for the donation account associated with the donee 112). As described in connection with the system 100, the retrieval of the data may include requesting data from and/or accessing one or more of the data structures 102a, 104a, 106a associated with the charity organization 102, the charity issuer 104, and the payment network 106, respectively. After the account data is retrieved, the donation engine 120 transmits the data back to the communication device 118, at 310, again via the donation application 122. Without limitation, the account data may include data relating to the donee profile, data relating to prior transactions performed using the donee's donation account, etc.

Alternatively in the method 300, or additionally, as indicated by the broken lines in FIG. 3, the communication device 118, via the donation application 122, may obtain, at 312, some or all data for the donation account from the donee device 116. For instance, the donee device 116 may include an embedded chip (e.g., embedded chip 458 of the donee device 416 illustrated in FIG. 4, etc.) that stores at least some of the donation account data for the donee 112 (e.g., data relating to identification of the donee 112, account restrictions, etc.), which can then be obtained by the donor communication device 118 from the donee device 116. In some embodiments, the donee device 116 may present donee account data such that it is unnecessary for the donation application 122 to request the donee account data from the donation engine 120 (at 306).

Then, once the donation account data has been received by the communication device 118, at the donation application 122 (whether from the donee device 116, the donation engine 120, or a combination thereof), the communication device 118 (via the donation application 122) displays the donation account data, or a subset thereof, at 314 (e.g., via presentation unit 206, etc.). The account data may be displayed through a user interface such as, for example, a graphical user interface (GUI), a text-based interface, or the like. As shown at 316, and as previously described, the account data may include (without limitation) an identification of the donee 112 (e.g., a name of the donee 112, a confirmation code potentially included on the donee device 116 for matching purposes, etc.), a picture/image of the donee 112, account restrictions for the donation account (e.g., the donation account may only be used for certain types of purchases or at certain merchants (or categories of merchants), a maximum spend for the donation account per week or per month (e.g., $500 per month, etc.), etc.), donation goals for the donee 112, and/or a transaction history for the donee 112 (e.g., a listing of transactions for the donation account for the last week, month, six months, etc.; a listing of the last five transactions, ten transactions, etc.). The transaction history for the donee 112, when included, may help enhance the donor's confidence that a donation will be used for appropriate purposes. Further, the donee 112 may be incentivized to maintain appropriate spending levels and patterns when making purchases using the donation account, knowing that his/her transaction history will be presented to the donor 114.

FIG. 5 illustrates an exemplary interface 500 that may be displayed to the donor 114, for viewing various account data for the donation account associated with the donee 112 (upon receiving an identifier for the donee device 116) (e.g., at 314 in the method 300, etc.). The illustrated interface 500 generally includes a name 502 of the donee 112 (i.e., Jane A. Smith) and a photo 504 of the donee 112. The donee name 502 and donee photo 504 may be included to provide the donor 114 with information that allows the donor 114 to confirm an identity of the donee 112 prior to making a donation. If the name 502 and/or photo 504 of the donee 112 included in the interface 500 conflict with other information that may be presented to the donor 114 (e.g., a visual appearance of the actual donee 112, etc.), the donor 114 may be alerted to a potentially fraudulent use of the donee device 116, and may choose to abort the donation process. The interface 500 also includes a section 506 identifying account restrictions for the donation account, a section 508 identifying donation goals for the donee 112, and a section 510 identifying past transactions imitated by the donee 112 using the donation account (i.e., a transaction history). As indicated in the restrictions section 506, the donation account cannot be used to purchase alcohol or tobacco, and cannot be used for gambling. The goals section 508 indicates progress of the donee 112 in connection with saving for rent, groceries, and transportation: “$250 out of $500 for Rent”, “$100 out of $200 for Groceries”, and “$0 out of $50 for Transportation.” And, the transaction history section 510 indicates that the donee's last transactions, using the donation account, relate to groceries, fuel, and utilities (suggesting responsible use of the funds in the donation account). Then, following review of the information in the interface 500, the donor 114 can select/elect to make a donation to the donee 112, via button 512.

Referring again to the method 300, when the donor 114 decides to make a donation to the donee 112, the communication device 118, via the donation application 122 solicits (or request) the donor 114 to define a donation, at 318. The donation may be based, at least in part, on the account data provided to the donor 114 at 314. For example, the donor 114 may choose to make a donation to one of the goals identified for the donee's account. With that in mind, and as shown at 320, various parameters that may be included (or defined) in the donation, by the donor 114, include a donation amount (e.g., a specific amount of money, a percentage of a donee goal, etc.), a source account to be used to fund the donation (e.g., the donation application 122 may enable the donor 114 to input multiple accounts from which he/she can fund donations, or may interact with an electronic wallet application at the communication to allow access to payment accounts therein for use in funding donations, etc.), donor authentication information (e.g., a PIN, a password, a biometric, etc.), and donor preferences for the donation. As previously described, the donor preferences/limitations may include, for example, applying donation funds to a specific goal of the donee 112, applying donation funds to a specific category of spending, disallowing use of the donation funds for a specific category of spending, assigning a time interval to set up a recurring donation, etc. As an example, the donor 114 may select that a donation go toward the donee's goal for tuition for next semester, the donor may select that the donation not be used for transportation purchases, and/or the donor may select to donate an amount to the donee once per month, once per week, or the like.

At 322, once the donation is defined by the donor 114, the communication device 118, via the donation application 122, generates and transmits a donation transaction to the payment network 106 based on the donation defined by donor 114. In particular, the communication device 118 may transmit the transaction to the charity organization 102, via the donation engine 120, which in turn generates and transmits an authorization request for the donation transaction consistent with the description provided above in connection with the system 100. In addition, the donation engine 120 records the transaction, at 324, to a data structure, for example, for subsequent reporting, for use in a donation drive or donation matching program, etc. It should be appreciated that the donation engine 120 may be located along path A in the system 100, so that it receives (or is at least aware of) the donation transaction (to thereby allow the donation engine 120 to record the donation transaction). Or, as previously described, the donation engine 120 may be implemented, at least in part, in one or more of the charity organization 102, the charity issuer 104, and the payment network 106, such that, via such association, the donation engine 120 is aware of the donation transaction and can record the donation transaction to an appropriate data structure.

FIG. 6 illustrates an exemplary interface 600 that may be displayed to the donor 114, at the communication device 118, for use in defining a donation and causing a donation transaction (e.g., at 318 and 322 in the method 300, etc.). In particular, the interface 600 may be displayed at the communication device 118, to the donor 114, upon selection of the donation button 508 in interface 500.

The illustrated interface 600 generally includes the name of the donee (i.e., Jane A. Smith) as a final confirmation that the donation is directed to the intended person, a field 602 to define an amount of the donation (i.e., $5.00), and a field 604 to identify (and/or select) a payment account for use in funding the donation. In this example, field 604 identifies multiple available payment accounts, associated with the donor 114, for use in the donation transaction (e.g., as previously provided by the donor 114, as retrieved from an electronic wallet associated with the donor 114, etc.). In particular in the interface 600, the donor 114 has three available payment accounts, with the third payment account, Acct # ****4567, highlighted/selected for use in the instant donation.

The interface 600 also includes a field 606 to allow the donor 114 to select a specific donee goal to which the donation should be applied. As previously described, the goals may be set by the donee 112, or they may be set by the charity organization 102 with which the donee 112 is associated. In this case, the available goals match those from the donee goals section 508 in the interface 500 of FIG. 5, with the “Transportation” goal highlighted/selected for application of the donation. The interface 600 further includes a field 608 to allow the donor 114 to set the donation as a recurring donation, or not. In FIG. 6, “None” is selected in this field 608, identifying the donation as a one-time donation.

Once the donation is defined in the interface 600, the donor 114 inputs a password, PIN, or other security input to authenticate the donor 114. And, the donor 114 then selects button 612 to accept and initiate the donation transaction. Conversely, if the donor 114 chooses to terminate the donation, he/she can select button 614 to decline the transaction and stop the process.

In view of the above, the systems and methods herein enable potential donors to make donations to donees using payment accounts at their communication devices, so that immediate funds are not necessary. What's more, in connection with making the donations, various assurances are provided to the donors to help confirm that the donations are directed to intended individuals and will be used in desired manners. Thus, the systems and methods of the present disclosure may allow for simple and safe donations in a manner not previously available.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) obtaining an identifier for a donee device associated with a donation account for an individual donee; (b) accessing data for the donation account based on the identifier, the data including one or more of: at least one donation goal for the donee, at least one spending restriction for the donation account, and an image of the donee; (c) displaying, to a donor, the accessed data for the donation account; (d) soliciting a donation from the donor for the donee; (e) causing a payment account transaction for the donation and/or transmitting a donation transaction, whereby when the payment account transaction is authorized, the donation is appended to the donation account for the individual donee; and (f) authenticating the donor prior to causing the payment account transaction for the donation.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

In addition, as used herein, the term product may include a good and/or a service.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating a donation transaction between a donor and a donee, the method comprising:
obtaining, by a computing device, an identifier for a donee device associated with a donation account for an individual donee;
accessing, by the computing device, data for the donation account based on the identifier from at least one data structure, the data including at least one donation goal for the donee;
displaying to a donor, by the computing device, the accessed data for the donation account;
soliciting, by the computing device, a donation from the donor for the donee; and
causing, by the computing device, a payment account transaction for the donation, whereby when the payment account transaction is authorized, the donation is appended to the donation account for the individual donee.

2. The method of claim 1, wherein obtaining an identifier for a donee device includes at least one of scanning an indicia associated with the donee device, receiving a network signal from the donee device, and receiving a manual input of the identifier for the donee device.

3. The method of claim 2, wherein accessing data for the donation account includes requesting and receiving the data from one or more of a charity organization associated with the donee and a charity issuer associated with the donation account.

4. The method of claim 3, wherein accessing data for the donation account includes receiving at least part of the data from the donee device.

5. The method of claim 1, wherein the at least one donation goal for the donee relates to one or more of a goal for rent, a goal for groceries, a goal for utilities, and a goal for transportation.

6. The method of claim 1, wherein the accessed data for the donation account further includes an image of the donee, spending restrictions for the donation account, and a transaction history.

7. The method of claim 6, wherein the spending restrictions for the donation account include spending restrictions related to one or more of a merchant, a merchant category, a product, a product category, and an amount of spend.

8. The method of claim 6, wherein accessing data for the donation account includes retrieving, via a payment network, the transaction history for the donation account.

9. The method of claim 1, wherein the donation includes a donation amount and an indication of the donee; and
wherein the donation further includes at least one of:
an indication to apply the donation amount to the at least one donation goal for the donee;
a limitation inhibiting use of the donation amount based on one or more of: i) one or more particular merchants, ii) merchants in one or more particular categories, iii) one or more particular products, and/or iv) one or more particular categories of products; and
a limitation allowing use of the donation amount only based on one or more of: i) one or more particular merchants, ii) merchants in one or more particular categories, iii) one or more particular products, and/or iv) one or more particular products of categories.

10. The method of claim 1, wherein soliciting a donation from the donor includes retrieving payment account data for the donor from an electronic wallet application associated with the computing device.

11. The method of claim 1, further comprising authenticating the donor, by the computing device, prior to causing the payment account transaction for the donation.

12. A computer-implemented method for use in facilitating a donation transaction between a donor and a donee, the method comprising:
receiving, by a computing device, data associated with a donation account for an individual donee, the data including at least one spending restriction for the donation account and an image of the donee;
displaying, by the computing device, to a donor, the at least one spending restriction for the donation account and the image of the donee;
receiving, by the computing device, a donation from the donor for the donee, the donation including a donation amount and an indication of the donee; and
transmitting, by the computing device, a donation transaction for the donation.

13. The method of claim 12, wherein the at least one spending restriction is selected from the group consisting of a spending restriction related to one or more merchants, a spending restriction related to one or more merchant categories, a spending restriction related to one or more products, a spending restriction related to one or more product categories, and a spending restriction related to one or more amounts of spend.

14. The method of claim 13, wherein the data associated with the donation account further includes a transaction history for the donation account; and
further comprising displaying, by the computing device, to the donor, the transaction history for the donation account.

15. The method of claim 14, wherein the data associated with the donation account further includes at least one donation goal for the donee; and
further comprising displaying, by the computing device, to the donor, the at least one donation goal for the donee.

16. The method of claim 15, wherein receiving data associated with the donation account includes receiving at least part of the data from a donee device associated with the donee; and
wherein the donee device is selected from the group consisting of a card, a fob, a wearable device, and a communication device.

17. The method of claim 15, wherein receiving a donation further includes one or more of:
receiving an indication, from the donor, to apply the donation amount to the at least one donation goal for the donee;
receiving a limitation, from the donor, inhibiting use of the donation amount based on one or more of: i) one or more particular merchants, ii) merchants in one or more particular categories, iii) one or more particular products, and/or iv) one or more particular categories of products; and
receiving a limitation, from the donor, allowing use of the donation amount based on one or more of: i) one or more particular merchants, ii) merchants in one or more particular categories, iii) one or more particular products, and/or iv) one or more particular categories of.

18. A non-transitory computer readable storage media comprising executable instructions for facilitating a donation transaction between a donor and a donee, which, when executed by a processor, cause the processor to:
retrieve data associated with a donation account for an individual donee, based on an identifier for a donee device associated with the donee, the data including one or more of a donation goal for the donee, a spending restriction for the donation account, and an image of the donee;
display at least part of the retrieved data to a donor at a communication device associated with the donor, such that the donor can review the data in connection with deciding to initiate a donation to the donee;
compile a donation for the donor to the donee in response to a donation input from the donor, the donation including a donation amount, an identification of a payment account associated with the donor for use in effecting the donation, and an indication of the donee; and
cause a payment account transaction for the donation to be generated and transmitted to an issuer associated with the payment account of the donor, whereby when the payment account transaction is authorized by the issuer, the donation amount is appended to the donation account for the individual donee.

19. The non-transitory computer readable storage media of claim 18, wherein the instructions, when executed by the processor, further cause the processor to authenticate the donor prior to generating the payment account transaction for the donation.

20. The non-transitory computer readable storage media of claim 18, wherein the donation further includes one or more of:
an indication to apply the donation amount to the at least one donation goal for the donee;
a limitation inhibiting use of the donation amount based on one or more of: i) one or more particular merchants, ii) merchants in one or more particular categories, and/or iii) one or more particular products; and
a limitation allowing use of the donation amount based on one or more of: i) one or more particular merchants, ii) merchants in one or more particular categories, and/or iii) one or more particular products.
